(19) United States
(12) Patent Application Publication
(10) Pub. No.: US 2008/0093381 A1
(43) Pub. Date: Apr. 24, 2008

(54) Dispensing Cap

(76) Inventors: Rhonda Kerryn Smith, Sunnybank Hills (AU); Colin Redmond, Red Hill (AU)

Correspondence Address: Fulbright & Jaworski, 865 South Figueroa, Twenty-ninth Floor, Los Angeles, CA, 90017-2517, US

(21) Appl. No.: 10/363,086

(22) PCT Filed: Sep. 11, 2001
(86) PCT No.: PCT/AU01/01138

§ 371 Date: May 16, 2006

(30) Foreign Application Priority Data
Sep. 11, 2000 (AU) PR 5007
Aug. 29, 2001 (AU) PR 7336

(51) Int. Cl. B67D 5/56; B65D 25/08

(52) U.S. Cl. 222/129; 206/222

(57) ABSTRACT

A dispensing cap (11) for a container, the cap having a closure member (16) movable from a first closed position to an open position in which fluid can pass through the cap, the closure member also being movable between the open position and a second closed position; and a chamber (24) for holding material to be dispensed from the cap, whereby the closure member is initially in the first closed position and when the closure member is moved to the second closed position, the material is released from the chamber.

### FIELD OF THE INVENTION

The present invention relates to a dispensing cap for use with a container and in particular a dispensing cap for use with a drink or beverage container. The present invention also relates to a lid assembly for a container.

### BACKGROUND OF THE INVENTION

The present invention will be described with particular reference to a cap for use with a beverage or drink container. However, it will be appreciated that the dispensing cap may be used with other types of container and no limitation is intended thereby.

Dispensing caps for dispensing a material contained in the cap into a container upon which the cap is mounted are known. Dispensing caps are used where it is desirable to keep components of a mixture separate until prior to use. This may be applicable in cases where some ingredients are unstable in solution.

Dispensing caps typically have a chamber for housing the material to be dispensed. In known caps, the chamber is typically separated from the main body of the container by a frangible membrane. The cap is typically provided with a means to rupture the membrane and to release the contents of the chamber. The membrane is typically ruptured by a piercing member. The piercing member may be urged towards the membrane by pushing downwardly on the upper end of the member.

In some caps, the piercing member must be removed from the cap after use to allow liquid to pass through the cap. However, this is often inconvenient to a user and further creates a separate waste item which must be disposed of.

In order to overcome this difficulty, some earlier caps allow the piercing member to become dislodged and fall into the body of the container after use. However, many users would prefer not to have a foreign object floating about in a beverage to be drunk.

One approach to this problem has been to modify known sipper type caps. Sipper caps have a push-pull type mechanism in which a spout is pulled to an open position through which fluid may be drunk and pushed to a closed position. Such caps are popular with cyclists and other sports persons as the push pull mechanism requires only a single handed operation when the spout can be gripped by a users teeth or mouth. The modified sipper caps have a frangible membrane which can be ruptured by the spout when the spout is pushed towards the closed position. However, this requires that the cap is in the open position before first use. This is undesirable as it may allow contamination of the material in the cap and/or leakage of fluid from the bottle.

It is therefore an object of the present invention to provide a dispensing cap which may at least partially overcome the above disadvantages or may provide the public with a useful choice.

### DESCRIPTION OF THE INVENTION

According to a first broad form of the invention, there is provided a dispensing cap for a container, the cap having a closure member movable from a first closed position to an open position in which fluid can pass through the cap, the closure member also being movable between the open position and a second closed position; and a chamber for holding material to be dispensed from the cap, whereby before use, the closure member is in the first closed position and when the closure member is moved to the second closed position, the material is released from the chamber.

The cap of the present invention is typically used with a beverage or drink container. Typically the container is a bottle which may be made from suitable materials such as PET, glass or polyolefin materials. The cap may be mounted to the container by any suitable means such as a snap fit, friction fit or be screw threaded.

The cap is typically a sipper cap of the type in which a drink may be drunk through the cap. In this case, the closure member may be in the form of a spout having one or more fluid flow apertures through which liquid may pass. The spout is typically slidably mounted within a collar. The collar typically has means for attaching the cap to a neck of a bottle. The spout is movable from a first closed position to an open position and between the open position and a second closed position. Typically when the spout is in the closed position, the fluid flow apertures(s) are blocked by a projection or the like.

In a preferred form of the invention the cap includes a stem which extends through the center of the spout. The spout is moveable with respect to the spout. The spout and/or stem may include one or more sealing projections which may be moved in and out of sealing engagement as the spout is moved by a user. In one form of the invention, the spout may include a pair of concentric sealing lips. The spout may be moved from a first closed position in which the stem seals against a first lip to an open position in which there is no sealing engagement between the spout and stem and a second closed position in which the stem contacts and seals against one or the other of the lips.

The cap includes a chamber for holding a material to be dispensed into the container. The material may be a liquid, powder, granules, tablet or the like. Where the container holds a beverage the material may include vitamins, minerals, other nutritional supplements, herbal extracts, medicines, colors, flavors, stabilizers and other additives known in the art.

When the closure member is moved to the second closed position, material is released from the chamber. Typically, the chamber has a sealing member. Generally, this sealing member forms a seal which can prevent liquid in the container from coming into contact with the material in the chamber. When the closure member is moved to the second closed position, the seal formed by the sealing member is broken so as to release the material. The seal may be broken by rupturing, deforming or moving the sealing member from a sealing to a material release position. Typically, the seal is broken by a seal breaking member which may be integral with or operatively associated with the closure member. Preferably, it is not possible to re seal the chamber after the seal has been broken.

In a preferred embodiment, the sealing member is cup shaped and is moveable to an inverted position to release the material.

According to a further broad form of the invention, there is provided a dispensing cap for a container, the cap having a chamber for holding material to be dispensed from the cap and into the container, the chamber having a sealing member wherein the sealing member is substantially U-shaped in cross section and is moveable from a material holding position to an inverted material releasing position.

The sealing member is typically formed from an elastomeric material which imparts an initial bias to the material holding position. However, during inversion, the sealing member is deformed to a substantially flat position, and the bias changes in favor of the inverted position. In this way the material can be quickly and efficiently released. Typically the sealing member is deformed by means of an annular member which can be actuated by an operator to push against the upper edges of the sealing member.

The cap of the second broad form may be of the push pull type in which liquid passes through a spout as described above. However it will be appreciated that this need not be the case. The cap of the second broad form may be of the type which is mounted to the neck of a container in a conventional manner and must be removed from the container to allow the contents of the container to be dispensed therefrom.

Caps of the push pull type typically include a protective cover or lid which may be associated with a tamper evident seal. The protective cover minimizes contamination of the spout and can protect against inadvertent or malicious activation of the cap prior to sale. Many users also prefer to replace the protective cover or lid if liquid contents of the container are not drunk at once. This is particularly so for cyclists who mount drinking containers to a bicycle frame. This mounting position allows dust, road grime and other contaminates to collect on the top of the spout.

One form of protective cover currently in use is a simple lid which snap fits to the housing of the cap. There are a number of disadvantages with such an arrangement. First, removal of the lid is a two handed procedure, and when removed the lid is easily lost. It can be seen that two handed removal is impractical for many sports people such as cyclists. Further, loss of the lid generates a separate waste item. To overcome this difficulty it has been proposed to connect the lid to the bottle neck or push pull cap. Some caps include a plastics tab connecting the cover to the cap. However, the tab is subject to failure after repeated use. Premature failure may be avoided by replacing the tab with a flexible plastics strap. However, in practice, the straps protrude from the body of the container and may catch on foreign objects. More advanced hinge designs have also been proposed. However, such designs may significantly add to the overall cost of the container. Such difficulties with covers and lids are not limited to caps of the push pull types but are also experienced with conventional types of container closures.

It is therefore a further object of the present invention to provide a lid assembly which may at least partially overcome the above disadvantages or provide the public with a useful choice.

According to a further broad form of the invention there is provided a lid assembly for a container, the assembly including a base mountable about an opening of the container, a cover member movable between a cover position and a free position and a hinge member hingedly connecting the cover and base, the hinge member having a first end attached to the cover and a second end attached to the base, and when the cover is in the cover position the first and second ends are angularly offset.

The lid assembly of the further broad from of the invention may be used with any suitable type of container or cap assembly and is not limited to use with caps of the other forms of the invention or caps of conventional push pull type. Typically the first and second ends are angularly offset between about 90 and 360_{θ}, and typically between about 100 to about 220_{θ}. It will be appreciated that by being angularly offset the hinge member can extend at least partially about the cover member in a spiral or helical configuration.

Preferably the hinge member lies substantially flush to the cover and base and does not protrude when the cover is in the cover position. The hinge member is typically a strip of a resilient plastics material and can function in the same manner as a coil of a spring to bias the cover towards the closed position. This may be advantageous in that should a user fail to return the cover to the cover position, the cover may at least partially return to the covering position, thereby avoiding or minimizing contamination of the underside of the cover and container contents by dirt, dust, airborne microorganisms and other debris.

The cover and base are typically engagable by known means such as a snap or friction fit.

### BRIEF DESCRIPTION OF THE FIGURES

FIG. 1 is a schematic cross sectional view of a preferred dispensing cap of the present invention attached to a beverage container;

FIG. 2 illustrates the cap of FIG. 1 in a first closed position;

FIG. 3 illustrates the cap of FIG. 1 in a second closed position;

FIG. 4 illustrates the cap of FIG. 1 in an open position;

FIG. 5 is a perspective view of a further preferred dispensing cap of the invention in a first closed position;

FIG. 6 is a cross-section of the cap of FIG. 5;

FIG. 7 is a perspective view of the cap of FIG. 5 in a second closed position;

FIG. 8 is a cross-section of the cap of FIG. 7;

FIG. 9 is a perspective view of the cap of FIG. 5 in an open position;

FIG. 10 is a cross-section of the cap of FIG. 9;

FIG. 11 is a perspective view of the spout of the cap of FIG. 5;

FIG. 12 is a perspective view of the stem and sealing member of the cap of FIG. 5 in a pre-release position;

FIG. 13 is a perspective view of the stem and sealing member of FIG. 12 in the release position;

FIG. 14 is a perspective view of the housing of the cap of FIG. 5.

FIG. 15 is a cross sectional schematic view of a further preferred dispensing cap of the present invention in a first closed position;

FIG. 16 is a cross sectional schematic view of the cap of FIG. 15 in a second closed position;

FIG. 17 is a cross sectional schematic view of the cap of FIG. 15 in an open position;

FIG. 18 is a perspective view of a cap of a further preferred embodiment of the invention;

FIG. 19 is a plan view of the cap of FIG. 18 and

FIG. 20 is a front view of a preferred lid assembly of a further embodiment of the invention.

### BEST METHOD OF PERFORMING THE INVENTION

FIG. 1 illustrates a dispensing cap 11 attached to a beverage container 12. The cap 11 has a housing 13 which has an internal screw thread for attachment to the neck of the container 12. The cap 11 has a top cover 14 which has a snap fit connection to the housing 13. Finger tab 8 facilitates a users grip on the cover 14 during opening. The cover 14 is connected to the housing 13 by a flexible connector 15. The cap 11 may be fitted with a tamper evident seal (although this forms no part of the invention).

The cap 11 has a tubular spout 16 which snugly fits within the housing 13 and is slidable in a vertical direction therein. A stem 17 is located within the spout 16. The spout 16 has upper 18 and lower 19 inwardly facing concentric lips. The stem 17 also has upper 21 and lower 22 outwardly facing concentric lips.

FIG. 2 illustrates the cap 11 in a first closed position after the cover 14 has been lifted away from the housing 13. It can be seen that the lower lip 19 of the spout 16 and the upper lip 21 of the stem 17 contact and provide a seal. Lip 22 projects over lip 19. A sealing member 23 is attached to the lower end of the stem 17. The sealing member 23 is in the form of a disc and seals against the inner wall 9 of the housing 13. A chamber 24 is defined by the sealing member 23 and inner wall 9 of the housing and contains a powder 25.

FIG. 3 illustrates the cap 11 in the second closed position. The spout 16 has been pushed downwards by a user until upper lip 18 contacts upper lip 21. The lower section 26 of the spout 17 has pushed the outer edges of the sealing member 23 downwards and away from the inner wall 9 of the housing 13. This breaks the seal and allows the powder 25 to be released into the body of the bottle in the direction of arrows A. The sealing member 23 is formed from a plastics material. The sealing member is designed such that when in the open position, it is biased into that position and cannot be returned to the sealed position.

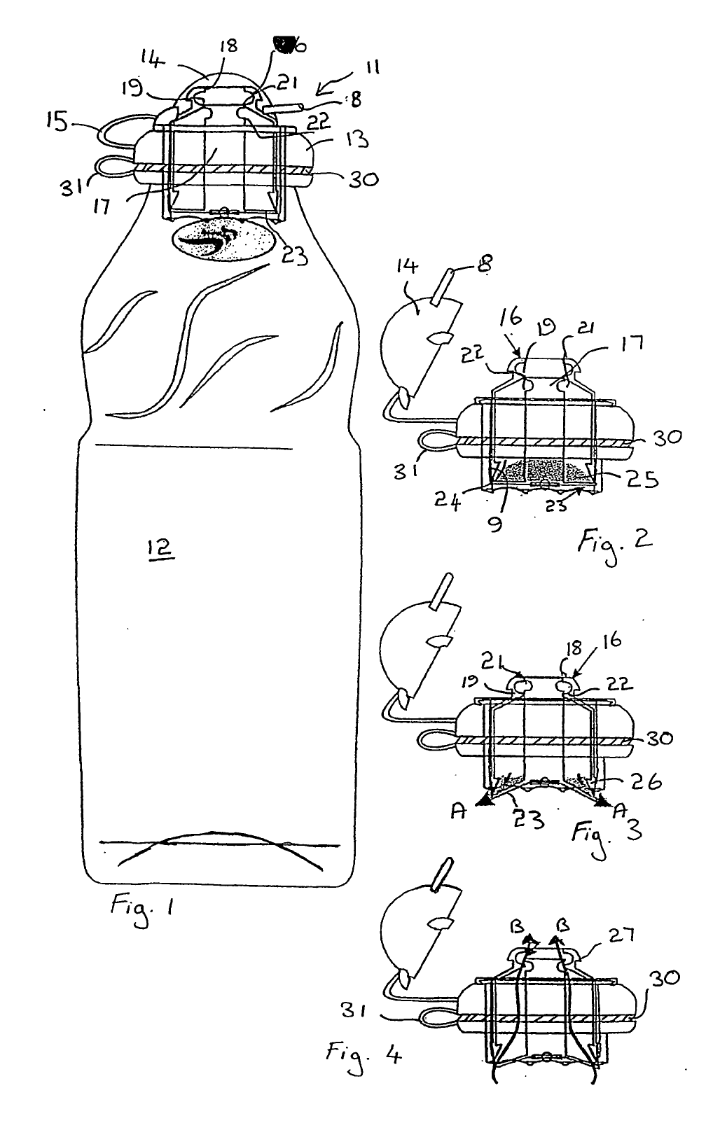

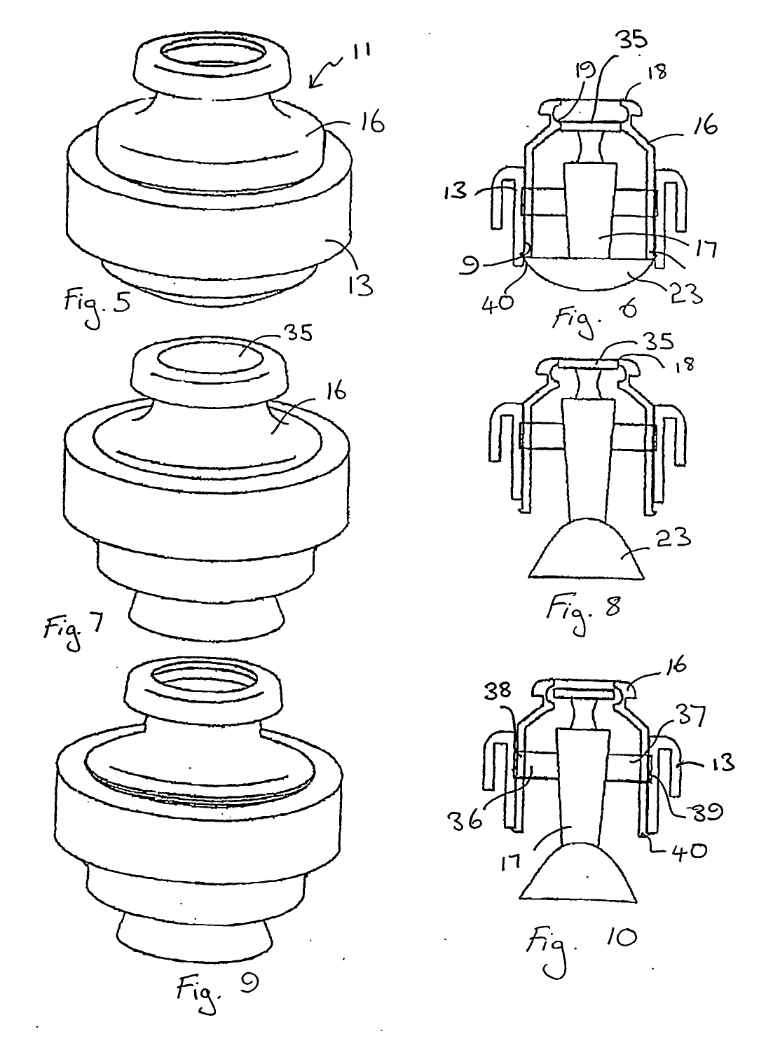

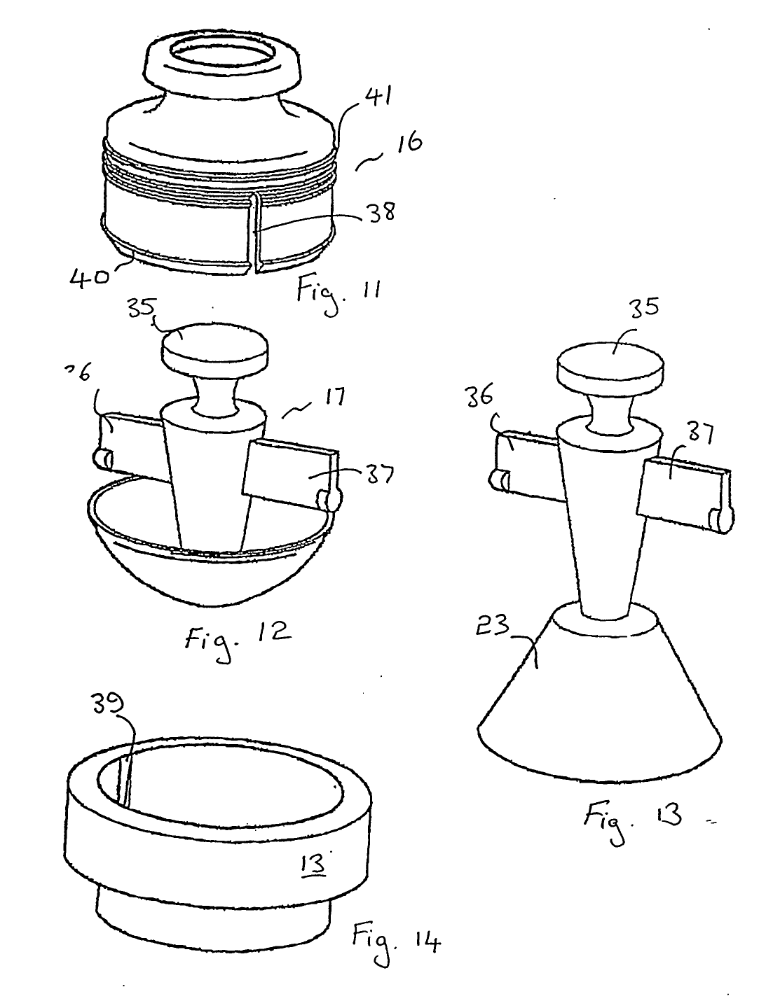

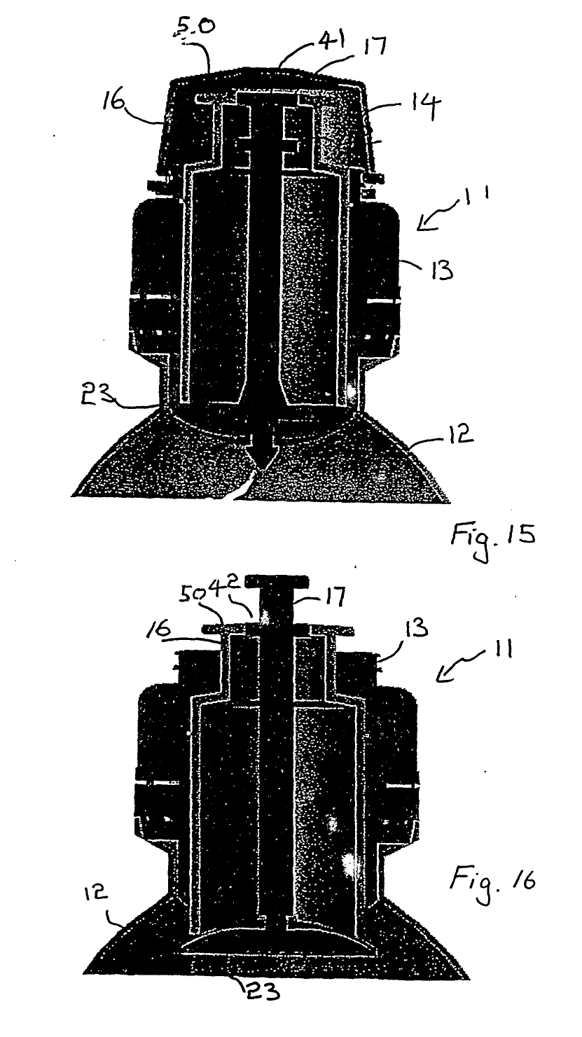

It can be seen that during release of the powder, contact between the respective upper portions of the stem 17 and spout 16 provides a seal so as to prevent liquid passing through the spout. This allows the bottle to be shaken to disperse and/or dissolve the powder upon its release into the bottle. After the liquid has been dispersed, the spout may then be raised to the position shown in FIG. 4. An outer lip 27 facilitates a user's grip on the spout 16. In this position, fluid can pass through the cap as illustrated by arrows B.

The cap 11 also has a frangible seal 30 which separates upper and lower sections of the housing 13. When this seal is broken, the upper part of the housing 13, together with the spout 16 and stem 17 may be lifted away from the bottle neck. The upper section however remains connected to the lower section through connecting member 31. This procedure allows a user access to the contents of the bottle without activating the spout and releasing the powder. This may be desirable if a user does not wish to drink the mixed beverage at that time. The upper section of the housing may be pivoted back into place and the powder released at a later stage. In this way, a user may also be able to obtain a more concentrated mixture, if desired, by releasing some of the fluid from the bottle before adding the powder.

The cap 11 may easily be assembled by first providing the housing 13 with the sealing member 23 intact. The powder is then added in the desired amount. The spout 16 is then slid into the housing. Premature activation of the spout to release the powder is inhibited by contact of the lower lip 19 of the spout 16 with the upper lip 21 of the stem 17. (The spout is made of a resilient plastics material such that, when required, a user may push the lower lip 19 past the upper lip 21). Also, a projection (not illustrated) is provided on the inner wall of the housing at a point just below the lower end of the spout. These projections are also resilient which enables a user to be able to push the spout downwards when activating the spout.

FIGS. 5 to 14 illustrate a further preferred dispensing cap of the invention. The same reference numerals have been used to identify the same or like parts. The cap 11 has a housing 13, spout 16 and stem 17. The stem 16 has an upper sealing disc 35 which seals against either the lower lip 19 of the spout 16 as shown in FIG. 6 or the upper lip 18 of the spout as shown in FIG. 8.

The sealing member 23 is made from an elastomeric plastics material and is cup shaped. In the pre-release position as shown in FIG. 6, the cup shaped sealing member 23 hold the material to be dispensed. As the spout 16 is pushed downward by a user, the lower portion of the spout pushes against the outer section of the sealing member. The sealing member is initially biased in the position shown in FIG. 6. As the sealing member approaches a substantially flat position, the bias changes towards the inverted position. Thus it is not necessary to push the outer edges of the sealing member 23 all the way to the release position as shown in FIGS. 8 and 10.

The stem 17 has a pair of diametrically opposed arm members 36, 37. These members 36, 37 extend through opposed apertures 38 in the spout 16. The apertures 38 are more clearly seen in FIG. 11. The ends of the arms 36, 37 are received by vertical slots 39 in the housing 13 (see FIG. 14). This arrangement holds the stem 17 in place relative to the housing 13. As the spout 16 is raised and lowered, the spout 16 is guided by the apertures 38 riding over arms 36, 37.

Pushing spout 16 downwards past the second closed position is prevented or inhibited by contact of the upper part of aperture 38 with arms 36, 37.

The lower end of the spout 16 has an upturned lip 40. The spout 16 is made from a resilient plastics material which allows the walls of the spout to be resiliently pushed inwardly during assembly to the position illustrated in FIG. 6 in which the lip 40 is located within the inner wall 9 of the housing 13. As the spout 16 is pushed downwards, to the position shown in FIG. 8, the resiliency of the spout 16 allows the lip 40 to spring outwardly such that lip 40 now extends below the lower edge of the housing wall 9. As can be seen from FIG. 10, raising of the spout 16 past the open position of FIG. 10 back to the first closed position in FIG. 6 is inhibited by contact of the lip 40 from the housing 13.

In practice, this is advantageous as it avoids or prevents a user upon pulling the spout 16 towards the open position from inadvertently moving the spout past the open position to the first closed position.

The spout 16 is also provided with a number of projecting ribs 41 which facilitate frictional engagement between the inner walls of the housing and the spout 16. This is shown in FIG. 11.

FIGS. 15 to 17 are schematic cross sectional views of a further preferred dispensing cap 11 of the present invention. This cap 11 similar to that of the previous figures and the same reference numerals are used to refer to same or similar features.

Cap 11 has a housing 13, spout 16, stem 17 and a cup shaped seal 23. However in this form of the invention spout 16 has a single upper sealing lip 50 and stem 17 has upper 51 and lower 52 concentric sealing members. The function of this portion will be described below.

The cap 11 shown in FIGS. 15 to 17 operates in a similar manner to that described above. FIG. 15 shows the cap 11 before use in a first closed position. An operator removes cover 14 to gain access to spout 16. The spout 16 is pushed downwards to a second closed position shown in FIG. 16 in which lower sealing member 42 of stem 17 seals against lip 50 of spout 16. As the spout 16 is pushed downwards, lower wall 43 of spout 16 pushes against and inverts sealing member 23 thereby releasing the contents of the cap into the bottle.

FIG. 17 shows the cap 11 in the open position in which fluid can flow through the spout 16.

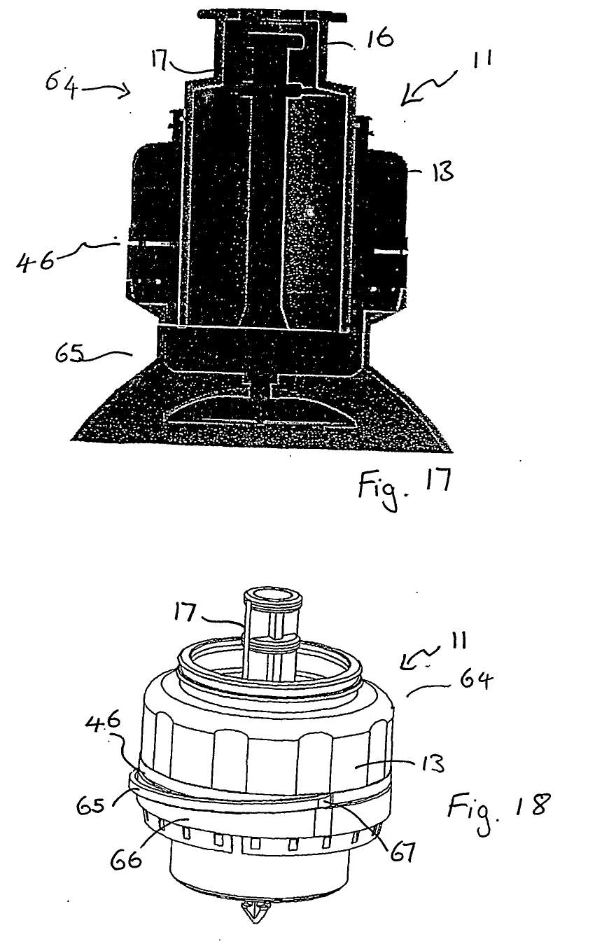

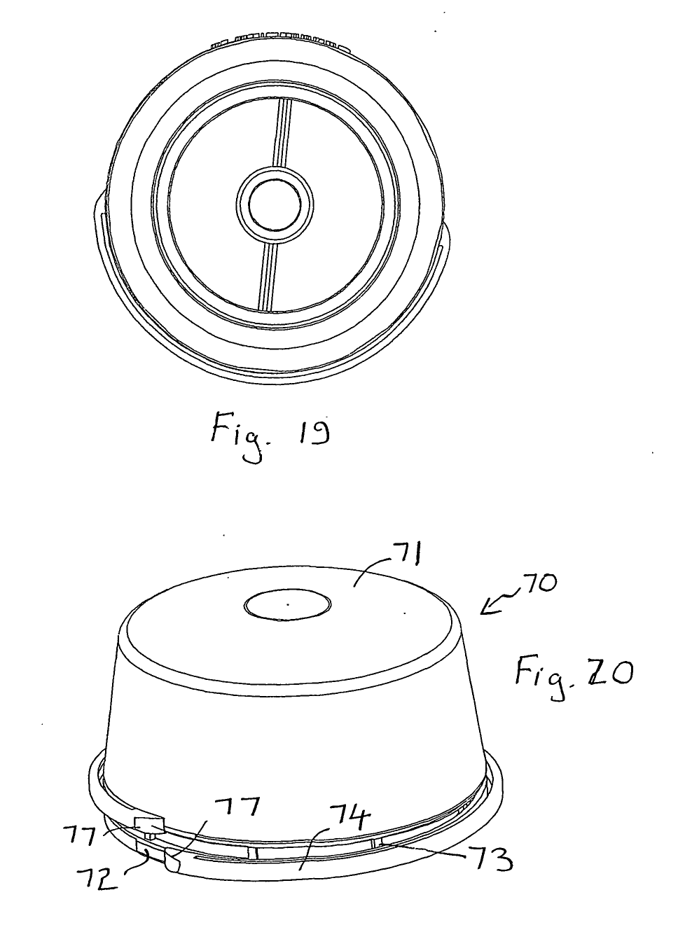

FIGS. 18 and 19 are respective perspective and plan views of the cap of FIG. 17. The housing 13 is separated into upper 64 and lower sections 65 by a frangible section 46 which can be broken such that upper section 64 including spout 16 and stem 17 are removed from the bottle. The upper 64 and lower 65 sections are connected by a hinge member 66. The hinge 66 has a first end 67 attached to upper section 64 and a second end 68 attached to lower section 65. The first 67 and second ends 68 are angularly offset 180_{θ}. Hinge member 66 sits snugly about the housing 13 and does not protrude as does the connecting member 31 of FIG. 1. When the upper section 64 is separated from the lower section 65, the hinge member 66 acts like the coil of a helical spring biasing the upper section 64 to the closed position.

FIG. 20 shows a lid assembly 70 of a further form of the invention. The assembly has a cover 71 and a locking band 72. Frangible tabs 73 connect the cover 71 and locking band 72. These tabs must be broken to open the cover in the first instance and thus function as a tamper evident seal. The locking band 72 typically locates in a groove in the neck of a container. A hinge member 74 has a first end 75 affixed to the cover 71 and a second end 76 affixed to band 72. Tabs 77, 78 are provided to provide a grip for a user's finger when opening the lid assembly.

In use the cover 71 is lifted away from the locking band 72. The two parts remain connected by hinge member 74. The hinge member 74 is formed from a resilient plastics material and its resiliency imparts a bias in the cover towards the cover position.

It may be seen that a dispensing cap of the present invention allows a material to be dispensed into a beverage prior to consumption in a relatively easy and straightforward manner. The cap remains sealed during release of the material to allow for mixing of the contents in the bottle by shaking. Also, the cap is sealed prior to the initial use. Further, the cap is self contained and does not require a separate seal breaking member which may fall into the body of a bottle after use or require separate disposal.

The lid assembly of the present invention provides a relatively simple and cost effective arrangement for hingedly connecting a cover member about the neck of a bottle.

It will also be appreciated that various changes and modifications may be made to the invention as described and claimed herein without departing from the spirit and scope of the invention.

The claims defining the invention are as follows:

1. A dispensing cap for dispensing a material into a container, the cap having a closure member moveable from a first closed position to an open position in which fluid can pass through the cap, the closure member also being moveable between the open position and a second closed position; and a chamber for holding the material to be dispensed from the cap, whereby before use, the closure member is in the first closed position and when the closure member is moved to the second closed position the material is released from the chamber.

2. The cap of claim 1, wherein the closure member is a spout and when in the open position, fluid can pass through the spout.

3. The cap of claim 2, including a stem extending through the spout and at least one sealing projection extending from the spout or stem which can seal against a portion of the other of the stem or spout.

4. The cap of claim 1 which includes first and second sealing projections extending from the stem and when the spout is in the first closed position, the first sealing projection seals against a portion of the spout and when in the second closed position, the second sealing projection seals against a portion of the spout.

5. The cap of claim 4, which includes an inwardly facing lip mounted on the spout and the first and second sealing projections can seal against the lip.

6. The cap of claim 1 which includes a sealing member which defines a base section of the chamber and the cap includes actuating means which can be manipulated by a user to actuate the sealing member to release the material from the chamber.

7. The cap of claim 6, wherein includes an actuating member for moving the sealing member to the material release position.

8. The cap of claim 7 wherein the actuating member is operatively associated with or integral with the closure member.

9. The cap of claim 6, wherein the sealing member is substantially U-shaped in cross section and is moveable from a material holding position to an inverted material release position.

10. The cap of claim 1 having a lower section which includes mounting means for mounting the cap to the container and an upper section which can be removed from the container whilst the lower section remains mounted to the cap and a hinge member connecting the upper and lower sections, the hinge member having a first end attached to the cover and a second end attached to the base and when the cover is in the cover position the first and second ends are angularly offset.

11. A dispensing cap for a container, the cap having a chamber for holding a material to be dispensed from the cap and into the container, the chamber having a sealing member which is substantially U-shaped in cross section and is moveable from a material holding position to an inverted material release position.

12. The cap of claim 10, wherein the sealing member is initially biased towards the material holding position and when moved towards the inverted position the bias changes towards the inverted position.

13. A lid assembly for a container, the assembly including a base mountable about an opening of the container, a cover member moveable between a cover position and a free position and a hinge member connecting the cover and base, the hinge member having a first end attached to the cover and a second end attached to the base and when the cover is in the cover position the first and second ends are angularly offset.

14. The lid assembly of claim 13 wherein said offset angle is between about 90° and 360°.

15. The lid assembly of claim 13, wherein the hinge member biases the cover member towards the cover position.
